(19) United States
(12) Patent Application Publication
(10) Pub. No.: US 2021/0062953 A1
(43) Pub. Date: Mar. 4, 2021

(54) CONCRETE PUMP HOSE CLEANING DEVICE

(71) Applicant: JOSE AGREDANO, Elgin, SC (US)

(72) Inventor: JOSE AGREDANO, Elgin, SC (US)

(21) Appl. No.: 16/556,287

(22) Filed: Aug. 30, 2019

(51) Int. Cl. F16L 55/46; B08B 9/055

(52) U.S. Cl. CPC F16L 55/46; F16L 2101/12; B08B 9/0552

(57) ABSTRACT

A concrete pump hose cleaning device. A receiver mounts to the concrete pump hose at an exit point of the concrete pump hose. The receiver receives and retains a clean out element as the clean out element exits the hose at high velocity. The receiver is constructed and arranged so at to not materially impede concrete and water that is forced from the hose during the cleaning process.

### BACKGROUND OF THE INVENTION

A concrete pump is a machine used for transferring liquid concrete from a first location to a second location. A concrete pump may be attached to a truck, or it may be mounted on a truck, or placed on a trailer. The concrete pump communicates with one or more placing hoses that are attached to the outlet of the concrete pump.

Concrete pumps and associated hoses must be cleaned after use to keep the concrete from setting in the concrete pump and hoses. Further, concrete is abrasive. Cleaning helps reduce wear on the equipment. Most commonly, a clean out element is forced through the hose(s) by either water pressure or air pressure. The clean out element may be a sponge rubber ball that is spherical in shape. The clean out element in some cases may have a geometry other than a sphere, and may be formed of materials other than sponge rubber.

The clean out element exists the hose at a high velocity. A sponge rubber ball absorbs water and concrete as it advances through the hose. The weight of the sponge rubber ball and the velocity on exit from the end of the hose presents a safety hazard to workers.

### SUMMARY OF THE INVENTION

The present invention is a concrete pump hose cleaning device. A receiver mounts to the concrete pump hose at an exit point of the concrete pump hose. The receiver receives and retains a clean out element as the clean out element exits the hose at high velocity. The receiver is constructed and arranged so at to not materially impede concrete and water that is forced from the hose during the cleaning process.

### BRIEF DRAWING DESCRIPTION

FIG. 1 shows an exemplary concrete pump, concrete hose and a concrete pump hose cleaning device according to the invention.

FIG. 2 is a perspective view of a concrete pump hose cleaning device according to the invention.

FIG. 3 illustrate a concrete pump hose cleaning device exploded away from a concrete pump hose.

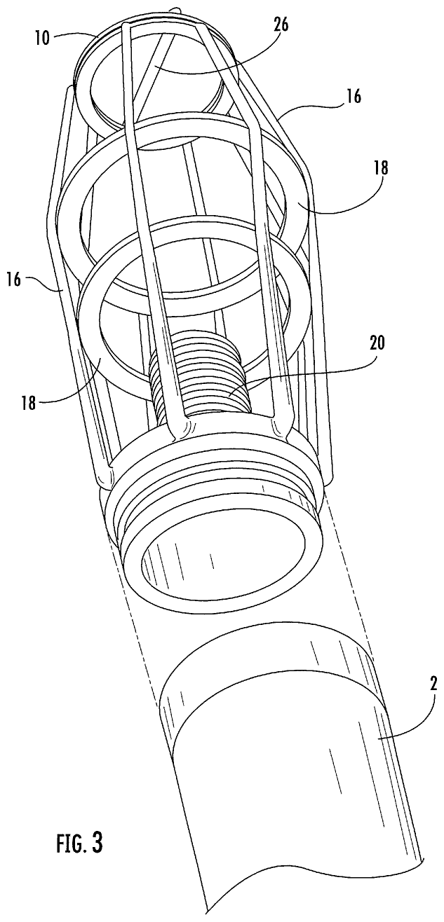

FIG. 4 shows a perspective view of a concrete pump hose cleaning device according to one embodiment of the invention.

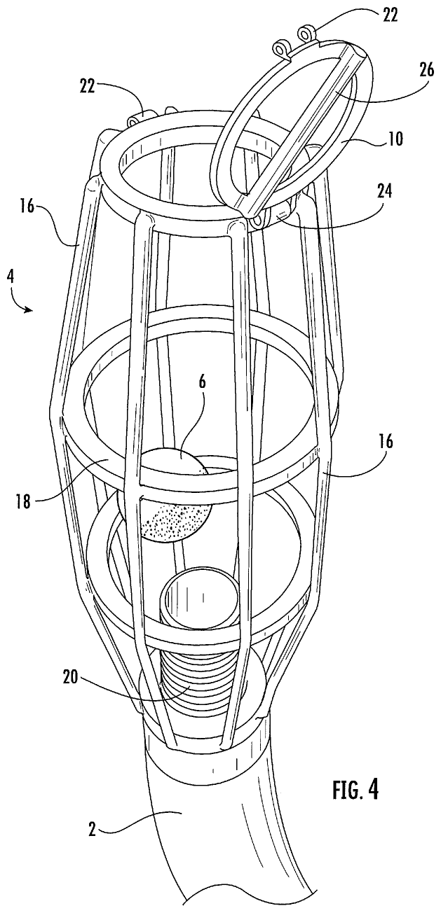

FIG. 5 is a perspective view of a concrete pump hose cleaning device according to another embodiment of the invention.

FIG. 6 is an additional view of the concrete pump hose cleaning device of FIG. 5.

### DESCRIPTION OF PREFERRED EMBODIMENTS

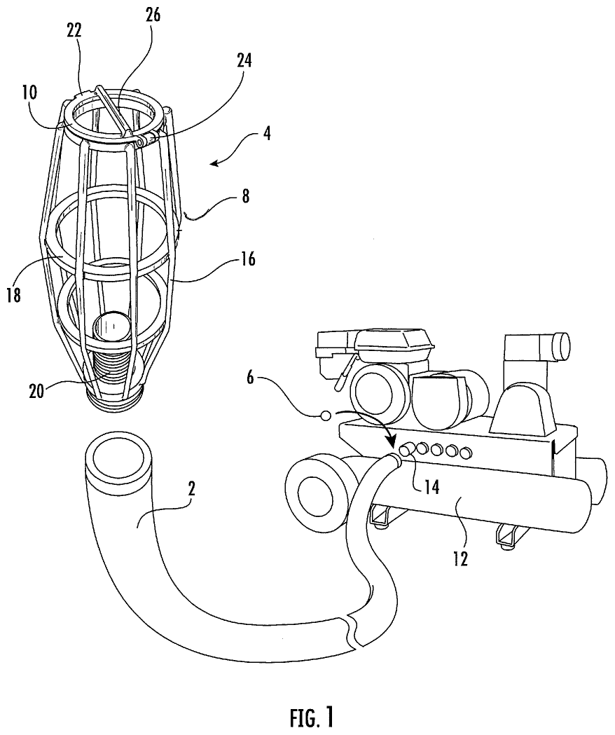

Turning now to the drawing figures, FIG. 1 shows a concrete pump. The embodiment of the concrete pump is given by of example and not limitation. Concrete pumps as used with the present invention may be of various configurations, and may be stand-alone pumps or pumps mounted to a truck, including a concrete mixer trucks.

FIG. 1 demonstrates a hose 2 that is fitted to an outlet of the concrete pump 12. In use, the hose is used to transport and distribute concrete from the concrete pump to a desired location. After concrete is pumped in a desired quantity to a particular location, the hose is cleaned to prevent the concrete from setting in the hose. Commonly, the concrete is cleaned from the hose using water under pressure. The pressurized water may be provided to the hose by the concrete pump. The concrete pump hose cleaning device 4 is mounted to the outlet 14 of the concrete pump hose. The clean out element 6 is inserted into the opposite end of the hose in one embodiment. The clean out element is commonly a sponge rubber ball of a selected density of foam rubber. Water pressure forces the ball through the hose, cleaning the hose as the ball travels. Water under pressure forces the ball to exit the outlet of the hose. The concrete pump hose cleaning device mounted to the hose receives and retains the ball, and prevents the ball from being forced at high velocity over a distance from the end of the hose so that workers are not injured by the clean out element as it exits the hose.

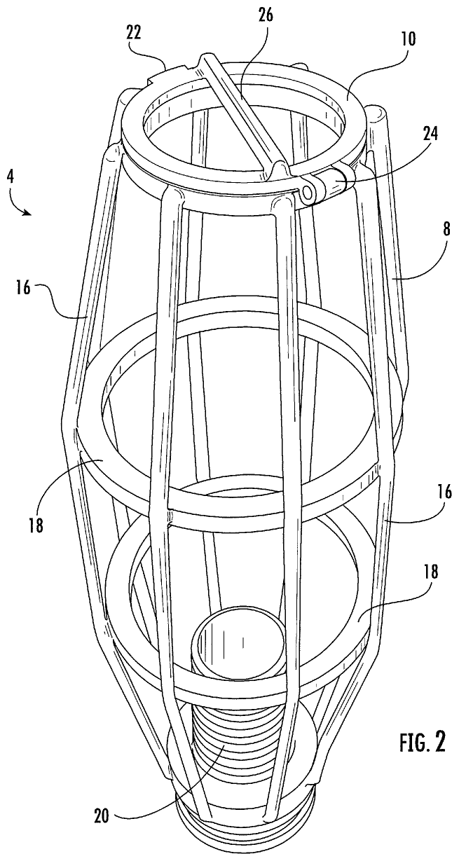

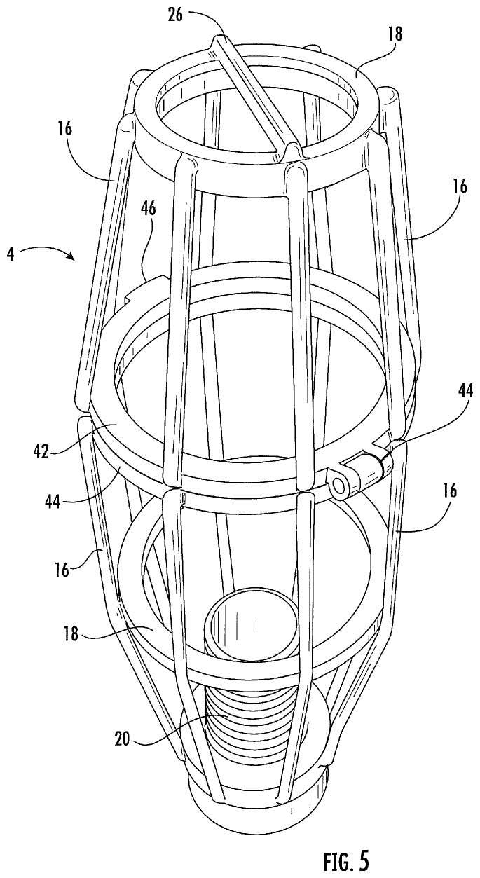

As shown in FIG. 2, the concrete pump hose cleaning device 4 has a receiver 8 that receives and retains the clean out element as it exits the hose. The receiver is constructed and arranged so that the vast majority of the exterior surface of the receiver is open. However, the construction of the receiver is such that the openings are not of sufficiently large dimensions to allow the clean out element 6 to escape the receiver when the receiver is in the formation shown in FIG. 2 or FIG. 5.

In a preferred embodiment, the receiver 8 is formed of a plurality of generally parallel and longitudinal strips 16 of metal, which may be steel. The longitudinal strips extend from a proximal end of the receiver to a distal end of the receiver. Intersecting strips 18 of metal are spaced apart and formed along the length of the receiver for structural support. The intersecting strips of metal intersect and connect the longitudinal strips of metal. The proximal end of the receiver is the end to which the hose 2 is connected. The distal end of the receiver is the end opposite the proximal end of the receiver.

As shown in the preferred embodiment, the receiver 8 progressively increases in cross sectional dimension from a proximal end toward a midsection of the receiver. The receiver progressively decreases in cross sectional dimension from the midsection of the receiver to a distal end of the receiver. This construct allows a clean out element 6 to exit the hose without a barrier to progress of the clean out element from the hose. The clean out element is subsequently directed toward the distal end of the receiver. Further, the enlarged midsection of the receiver provides plenty of area for concrete received from the hose to exit the receiver so that the receiver is not clogged with concrete.

In a preferred embodiment, the enlarged area of the midsection of the receiver 8 is created by annular intersecting strips 18 of metal. The intersecting strips of metal may be round in shape as shown, but may be rectangular, hexagonal, octagonal, or other geometric configurations. However, the annular intersecting strips of metal nearest the proximal end will be smaller than one or more intersecting strips of metal at the midsection. The intersecting strips of metal near the midsection may be of larger diameter than the intersecting strips of metal that form the distal end of the receiver, or otherwise constructed to provide an increased circumference of the receiver at the midsection as compared to the distal and proximal ends of the receiver.

The midsection may extend along a length of the receiver 8 that is present between the proximal end and the distal end of the receiver. The term “midsection” as used herein is not meant to be limited to the midway point between the proximal end and the distal end, or to refer to the particular intersecting strip that is positioned between the two other intersecting strips as shown in the drawings.

The receiver 8 is constructed and arranged to connect to the outlet 14 of the concrete pump hose 2. The exact construct for attaching the receiver will depend upon the concrete pump hose that is used. For example, in some configurations a clamp, such as a hose clamp, may be used. In other configurations a threaded engagement between the concrete pump hose and the receiver may be used. In other embodiments, an interference fit between the concrete pump hose and the receiver may be sufficient to maintain the receiver in place during the clean out process.

In the preferred embodiment that is shown, a hose extension 20 is provided for the concrete pump hose cleaning device 4. The hose extension extends from the distal end of the receiver into a portion of the interior of the receiver. The hose extension acts as a guide to direct the clean out element 6 from the hose 2 into the receiver.

The construct of the receiver 8 provides a substantial open area so that concrete and water at high volume and pressure can easily exit the receiver. However, the relationship between the longitudinal strips 16 of metal and the intersecting strips 18 of metal is such that none of the areas of spacing between the strips is sufficiently large to allow the clean out element 6 to exit the receiver when the receiver is in the closed configuration shown in FIG. 2 or FIG. 5. However, it is necessary to be able to remove the clean out element from the receiver.

In one preferred embodiment, the construct of the distal end of the receiver 8 provides a hinged cap 10. The hinged cap is hingedly connected to the intersecting strip of metal as shown in FIG. 2. A latch 22 is spaced apart from the hinge 24. In a preferred embodiment, the latch is positioned opposite the hinge. The cap as shown comprises a barrier 26, which may be a strip of metal that intersects an opening of the cap. This barrier divides the cap so that the clean out element 6 cannot exit through the opening in the cap. At the same time, the vast majority of the cap is open, with openings present on either side of the barrier.

In the embodiment shown in FIG. 5, there is no hinged cap. Rather, the intersecting strip of metal at the midsection is formed in two parts 40, 42 that are hingedly connected. A hinge 44 is provided to connect the two intersecting strips of metal. A latch 46 is spaced apart from the hinge, and in a preferred embodiment, is opposite the hinge. With the receiver 8 and the latch in the closed position as shown in FIG. 5, the clean out element 6 cannot escape the receiver. In this embodiment, the barrier may be a cap 10 having a dimension that is sufficiently small to prevent the clean out element from escaping from the receiver though the distal end of the receiver.

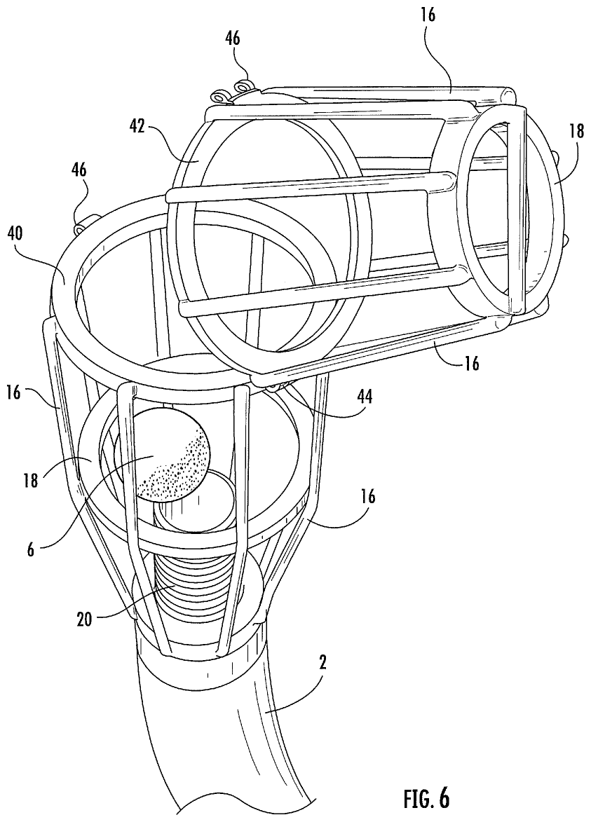

When the latch 46 is opened as shown in FIG. 6, a portion of the receiver 8 that comprises the distal end of the receiver may be pivoted relative to the hinge and away from the portion of the receiver that comprises the proximal end. The clean out element may be retrieved through the opening provided.

What is claimed:

1. A concrete pump hose cleaning device, comprising:
a receiver having a proximal end constructed and arranged to mount to a concrete pumping line, the receiver increasing in cross-sectional dimension to a midsection of the receiver, and decreasing in cross-sectional dimension from the mid-section of the receiver to a distal end of the receiver, wherein the distal end of the receiver comprises an opening having a barrier positioned in the opening.

2. A concrete pump hose cleaning device as described in claim 1, wherein the receiver comprises a hinge positioned at the midsection of the receiver and a latch positioned at the midsection of the receiver.

3. A concrete pump hose cleaning device as described in claim 1, wherein the receiver comprises a hinge positioned at the distal end of the receiver and a latch positioned at the distal end of the receiver.

4. A concrete pump hose cleaning device as described in claim 1, wherein the receiver has a plurality of openings on an exterior surface of the receiver.

5. A concrete pump hose cleaning device as described in claim 1, the receiver increasing in circumference from a proximal end of the receiver to the midsection of the receiver, and decreasing in circumference from the midsection to a distal end of the receiver.

6. A concrete pump hose cleaning device as described in claim 1, wherein the receiver construct is formed by a plurality of longitudinal strips that extend from the proximal end to the distal end, and a plurality of intersecting strips formed along the length of the receiver that intersect the longitudinal strips of metal, the plurality of longitudinal strips and the plurality of intersecting strips forming openings on an exterior surface of the receiver.

7. A concrete pump hose cleaning device as described in claim 1, wherein the distal end of the receiver comprises an opening on each side of the barrier.

8. A concrete pump hose cleaning device as described in claim 1, wherein the opening at the distal end of the receiver is divided by the barrier so that the barrier forms a first opening and a second opening at the distal end of the receiver.

9. A concrete pump hose cleaning device as described in claim 1, wherein the receiver comprises a first intersecting strip of the plurality of intersecting strips and a second intersecting strip of the plurality of intersecting strips that are hingedly connected at the midsection of the receiver, and the receiver further comprises a latch that connects the first intersecting strip of metal to the second intersecting strip of metal.
